(19) United States
(12) Patent Application Publication
(10) Pub. No.: US 2005/0203256 A1
(43) Pub. Date: Sep. 15, 2005

(54) Poymer obtained by means of controlled radical polymerisation comprising at least one boronate function, association thereof with a ligand compound and uses of same

(76) Inventors: Mathias Destarac, Paris (FR); Bruno Bavouzet, Gentilly (FR); Wojciech Bzducha, Courbevoie (FR)

Correspondence Address: Jean-Louis Seugnet;Rhodia Inc, Intellectual Property Dept, 259 Prospect Plains Road CN-7500, Cranbury, NJ, 08512-7500, US

(21) Appl. No.: 10/514,363

(22) PCT Filed: May 14, 2003
(86) PCT No.: PCT/FR03/01302

§ 371 Date: Apr. 28, 2005

(30) Foreign Application Priority Data
May 14, 2002 (FR) 0205983

(51) Int. Cl. C08F 8/42; C08B 37/00

(52) U.S. Cl. 525/337; 536/114

(57) ABSTRACT

A subject-matter of the present invention is a polymer capable of being obtained by controlled radical polymerization of at least one monomer comprising a boronate or precursor functional group and of at least one monomer which is devoid thereof. A subject-matter of the present invention is likewise the combination comprising the abovementioned polymer with at least one monomer, oligomer or polymer or one organic or inorganic surface having at least one group capable of complexing with a boronate or precursor functional group of the polymer according to the invention. Finally, the invention relates to the preparation of this combination and to its use.

A subject-matter of the present invention is a polymer comprising at least one boronate functional group or one precursor functional group which is obtained by controlled radical polymerization, its combination with a compound having at least one group which is reactive with regard to a boronate functional group, the preparation of the combination and their uses.

Polymers comprising boronate functional groups or their precursors can have numerous applications. This is because, on being combined with compounds having groups which are reactive with regard to the boronate functional groups, they can modify the rheological behavior of these compounds when they are in solution, just as they can modify the affinity thereof with regard to certain substances or surfaces.

It is known to prepare polymers having boronic or boronate functional groups by conventional radical polymerization and they can be used in particular in medical applications or in chromatography.

The difficulty lies in the fact that the resulting polymers exhibit numerous heterogeneities, both with regard to the distribution in mass of the various chains obtained and the composition of each of them.

Furthermore, conventional radical polymerizations are far from being effective when it is a matter of incorporating, in a chain, a low content of a specific monomer. Thus, the phenomenon of variation in composition of chains mentioned above is accentuated with respect to the cases where the content of specific monomer is high, even if such phenomena also exist. A not insignificant proportion of chains which are either devoid of the desired monomer or which exhibit an excessively high content of the latter is thus obtained.

In point of fact, in certain applications, such heterogeneities can result in significant difficulties, indeed even unacceptable difficulties, during the use of these polymers.

This is because, when polymers comprising boronate functional groups are combined with compounds, known as ligand compounds, which are more particularly polymers and which have groups which are reactive with regard to such functional groups, the appearance of a phenomenon of excess crosslinking between the boronate chains and the ligand compound may be observed, which can result in the undesired formation of a gel, in the best of cases, or indeed even the precipitation of the grouping, in the worst case.

In the case where a small content of boronate monomer is present, a good number of chains are ineffective as they do not comprise boronate monomer or have an excessively low content of this monomer, and those which comprise the monomer can cause complications of the same nature as those mentioned in the preceding case.

Another consequence of the absence of control of the structure of the polymer carrying boronate functional groups is their very poor ability to modify the general structure of a ligand compound, more particularly when the polymer comprising boronate functional groups is used as a graft capable of complexing with the backbone of the ligand compound.

This is because conventional radical polymerizations do not make it possible to place in position in a relatively specific way the boronate or precursor functional groups, just as they do not make it possible to access block polymers.

It is therefore an object of the present invention to provide polymers comprising boronate functional groups or precursors of such functional groups which exhibit good homogeneity in the length of the chains but also in the compositions of the chains themselves, this being the situation even when the boron content of the polymer is low.

These aims and others are achieved by the present invention, a first subject matter of which is a polymer capable of being obtained by controlled radical polymerization of at least one monomer comprising a boronate or precursor functional group and of at least one monomer which is devoid thereof.

A subject-matter of the present invention is likewise the combination of the abovementioned polymer with at least one monomer, oligomer, polymer or organic or inorganic surface having at least one group capable of complexing with a boronate or precursor functional group of the polymer according to the invention. Subsequently, these compounds will be referred to without distinction as ligand compounds.

A subject-matter of the present invention is furthermore the use of the abovementioned combination, according to which said combination is employed in an aqueous medium with a concentration such that the content by weight of the polymer is between 0.001 and 50% by weight in the aqueous medium.

The polymers according to the invention exhibit the advantage of having a narrow distribution in mass and of having an appropriate homogeneity in composition from one chain to another.

Furthermore, according to one embodiment of the invention, some polymers, due to their method of synthesis, exhibit a controlled microstructure of chains, resulting in block structures. Furthermore, the positioning of the boronate or precursor functional groups in the polymer chain is itself also controlled.

Furthermore, the fact that some polymers according to the invention exhibit a block structure promotes better control of the structure and of the properties of the combination of the polymers with a ligand compound.

Thus, the use of these polymers in combination with ligand compounds makes it possible to obtain optimum structures which can be achieved in a considerably more simplified way than by employing conventional polymerization reactions, if, however, these reactions, made it possible to achieve such results.

Furthermore, such combinations can condition a specific rheological behavior but can also make it possible to vectorize a compound onto a macroscopic surface (fabric, hair, and the like) by introducing into the ligand compound an affinity which it did not have previously. The combination can also make it possible to modify the properties of a compound, which will then develop an affinity for a novel medium (transfer of phases, and the like) or a liquid/liquid (emulsion), liquid/air (foam) or liquid/solid (dispersion) interface.

Furthermore, the bonds between the polymer comprising boronate functional groups and the ligand compound may or may not be promoted depending on the conditions of use of this combination, more particularly depending on the pH or else the presence or absence of a competitive molecule. Consequently, depending on these conditions, it is possible to observe an effect of triggering the reaction of the boronate or precursor functional group with the antagonist functional group, or of destabilization of the bond.

It should also be noted that this homogeneity in structure restricts any risk of incompatibility during use which may become apparent when the chains exhibit excessively high contents of boronate functional groups.

Furthermore, by virtue of the homogeneity in composition and in length of the chains, all the polymer chains are effective and the amounts employed during use are therefore optimized; in other words, the amounts required are lower.

In addition, the polymers according to the invention can, in some alternative forms, exhibit relatively precise positioning of the boron along the chain.

This is a not insignificant advantage when these polymers are used as agents for grafting ligand compounds. This is because, if the boronate functional groups are found at one of the ends of the chain, it may be expected that the entity resulting from the combination of said polymer comprising the boronate functional groups with a ligand compound of polymeric nature will have either a comb polymer structure, in the case of a linear ligand compound in solution, or a more or less swollen crown structure, in the case of a ligand compound in the form of a particle (organic particle, such as a latex, or inorganic particle).

However, other characteristics and advantages of the present invention will become more clearly apparent on reading the description and examples which will follow.

First of all, it should be remembered that boronate functional groups are functional groups corresponding to the following formula —B(OH)₃—, possessing a counterion such as a monovalent ion chosen in particular from alkali metals. They originate from the neutralization of the boronic acid functional group of the formula: —B(OH)₂, which functional group is a weak acid which can be neutralized by a strong or weak base. It is specified that the term “boronate” will be used subsequently, unless otherwise mentioned, to denote a boronic acid functional group or a boronate functional group in the salt form.

The term “precursor of the boronate functional groups” denotes functional groups of boronate ester type —B(OR)₂, where the abovementioned R radical corresponds to an alkyl functional group, or of borane type —BH₃ .

As was indicated above, a first subject-matter of the invention is a polymer capable of being obtained by controlled radical polymerization of at least one monomer comprising a boronate or precursor functional group and of at least one monomer which is devoid thereof.

Depending on the nature of the monomers participating during the synthesis, the polymers according to the invention may or may not be water-soluble.

The term “water-soluble” denotes polymers which, at 20° C. and at a concentration in aqueous solution of 0.1% by weight, do not result in the appearance of macroscopic phase separation after one hour.

This represents an additional advantage of the compounds according to the invention as, depending on their solubility in water, they can be used in aqueous formulations, if they are water-soluble, or else, if they are not water-soluble, they can be used as agent for modifying the solubility in the aqueous phase of water-soluble ligand compounds.

More particularly, the monomer comprising the boronate or precursor functional group is chosen, for example, from acryloylbenzeneboronic acid, methacryloylbenzeneboronic acid, 4-vinylbenzeneboronic acid, 3-acrylamidophenylboronic acid or 3-methacrylamidophenylboronic acid, alone or as mixtures, or in the form of salts.

According to an advantageous embodiment of the present invention, the content of monomer comprising the boronate or precursor functional group is between 0.01 and 50 mol % with respect to the total number of moles of monomers present in the polymer, more particularly between 0.01 and 15 mol % with respect to the same reference, preferably between 0.1 and 4 mol % with respect to the same reference.

As indicated above, the polymer according to the invention is obtained by controlled radical polymerization in the presence, on the one hand, of at least one monomer comprising a boronate or precursor functional group which has just been described in detail and of at least one monomer which is devoid of this type of functional group.

The choice of the other monomer or monomers devoid of boronate or precursor functional group depends on the characteristic according to which the resulting polymer must or must not be water-soluble within the meaning of the invention.

The choice also depends on the future applications which are made of the resulting polymers.

This is because, when the polymer is combined with a ligand compound, that is to say with an entity having one or more functional groups which are reactive with regard to the boronate functional group, the nature of said polymer confers specific physicochemical characteristics on the combination.

For example, the chain of the polymer according to the invention (or polymer comprising boronate functional group) can contribute not only a hydrophobic or more hydrophobic, hydrophilic or more hydrophilic, amphiphilic nature, but also ionic functional groups, an amphoteric nature, a cloud point, and the like, to the entity with which it is combined.

Thus, the monomer or monomers devoid of the boronate functional group or its precursor can be chosen from hydrophobic monomers.

Mention may be made, as illustration of this type of monomer, of:
esters of linear, branched, cyclic or aromatic mono- or polycarboxylic acids comprising at least one ethylenic unsaturation which are optionally fluorinated and which optionally carry a hydroxyl group,
α,β-ethylenically unsaturated nitrites, vinyl ethers, vinyl esters, vinylaromatic monomers, vinyl halides or vinylidene halides,
linear or branched and aromatic or nonaromatic hydrocarbonaceous monomers comprising at least one ethylenic unsaturation, alone or as mixtures, and the macromonomers deriving from such monomers.

It should be remembered that the term “macromonomer” denotes a macromolecule carrying one or more polymerizable functional groups.

The following are more particularly suitable:
esters of (meth)acrylic acid with an alcohol comprising 1 to 12 carbon atoms, such as methyl (meth)acrylate, ethyl (meth)acrylate, propyl (meth)acrylate, n-butyl (meth)acrylate, tert-butyl (meth)acrylate, isobutyl (meth)acrylate or 2-ethylhexyl acrylate;
vinyl acetate, vinyl versatate®, vinyl propionate, vinyl chloride, vinylidene chloride, methyl vinyl ether or ethyl vinyl ether;
vinyl nitriles, including more particularly those having from 3 to 12 carbon atoms, such as, in particular, acrylonitrile and methacrylonitrile;
styrene, α-methylstyrene, vinyltoluene, para-methylstyrene, para-(tert-butyl)styrene, butadiene, isoprene or chloroprene;
   alone or as mixtures, and the macromonomers deriving from such monomers.

The preferred monomers are the esters of acrylic acid with linear or branched C₁-C₄ alcohols, such as methyl acrylate, ethyl acrylate, propyl acrylate and butyl acrylate, vinyl esters, such as vinyl acetate, styrene and α-methylstyrene.

The polymer according to the invention can also be obtained by polymerization of hydrophilic monomers chosen from amides of linear, branched, cyclic or aromatic mono- or polycarboxylic acids comprising at least one ethylenic unsaturation, or derivatives, such as (meth)acrylamide or N-methylol(meth)acrylamide; cyclic amides of vinylamine, such as N-vinylpyrrolidone; N-vinyl monomers, such as N-vinylcaprolactone, N-vinylcaprolactam or N-vinylacetamide; ethylenic monomers comprising a ureido group, such as ethylene urea ethyl (meth)acrylamide or ethylene urea ethyl (meth)acrylate; hydrophilic esters deriving from (meth)acrylic acid, such as, for example, 2-hydroxyethyl (meth)acrylate; or vinyl esters which make it possible to obtain poly(vinyl alcohol) blocks after hydrolysis, such as vinyl acetate, vinyl versatate® or vinyl propionate, alone or in combination, and the macromonomers deriving from such monomers.

However, the preferred hydrophilic monomers are acrylamide, methacrylamide and N-vinylpyrrolidone, alone or as a mixture, or in the macromonomer form.

In accordance with another possibility, the polymer according to the invention can be obtained from at least one monomer chosen from monomers comprising at least one carboxylic, sulfonic, sulfuric, phosphonic, phosphoric or sulfosuccinic functional group or the corresponding salts.

In particular, the following monomers can be employed in the presence of the monomer or. monomers comprising the boronate functional group or its precursor:
linear, branched, cyclic or aromatic mono- or polycarboxylic acids, the N-substituted derivatives of such acids, or the monoesters of polycarboxylic acids, comprising at least one ethylenic unsaturation;
linear, branched, cyclic or aromatic vinylcarboxylic acids;
amino acids comprising one or more ethylenic unsaturations;
   alone or as mixtures, their precursors, their sulfonic or phosphonic homologs, and the macromonomers deriving from such monomers; it being possible for the monomers or macromonomers to be in the form of salts.

Mention may be made, as examples of monomers, without intending to be limited thereto, of:
acrylic acid, methacrylic acid, fumaric acid, itaconic acid, citraconic acid, maleic acid, acrylamidoglycolic acid, 2-propene-1-sulfonic acid, methallylsulfonic acid, styrenesulfonic acid, α-acrylamidomethylpropanesulfonic acid, 2-sulfoethylene methacrylate, sulfopropylacrylic acid, bis(sulfopropyl)acrylic acid, bis(sulfopropyl)methacrylic acid, sulfatoethylmethacrylic acid, the phosphate monoester of hydroxyethylmethacrylic acid, and the salts of an alkali metal, such as sodium or potassium, or of ammonium;
vinylsulfonic acid, vinylbenzenesulfonic acid, vinylphosphonic acid, vinylidenephosphoric acid, vinylbenzoic acid, and the salts of an alkali metal, such as sodium or potassium, or of ammonium;
N-(methacryloyl)alanine or N-(acryloyl)hydroxyglycine;
   alone or as mixtures, and the macromonomers deriving from such monomers.

It would not be departing from the scope of the present invention to employ monomers which are precursors of those which have just been mentioned. In other words, these monomers exhibit units which, once incorporated in the polymer chain, can be converted, in particular by a chemical treatment, such as hydrolysis, to restore the abovementioned anionic entities. For example, the completely or partially esterified monomers of the abovementioned monomers can be employed in order, subsequently, to be completely or partially hydrolyzed.

Finally, another possibility consists in carrying out the controlled radical polymerization in the presence, in addition to the monomer or monomers comprising the boronate functional group or its precursor, of at least one monomer chosen from:
aminoalkyl (meth)acrylates or aminoalkyl(meth)acrylamides;
monomers comprising at least one secondary, tertiary or quaternary amine functional group or one heterocyclic group comprising a nitrogen atom, vinylamine or ethyleneimine;
diallyldialkylammonium salts;

alone or as mixtures, or the corresponding salts, and the macromonomers deriving from such monomers.

Said monomers can exhibit a counterion chosen from halides, such as, for example, chlorine, sulfates, hydrogensulfates, alkyl sulfates (for example comprising 1 to 6 carbon atoms), phosphates, citrates, formates or acetates.

Examples of suitable monomers include, inter alia, the following monomers:
dimethylaminoethyl (meth)acrylate, dimethylaminopropyl (meth)acrylate, di(tert-butyl)aminoethyl (meth)acrylate, dimethylaminomethyl(meth)acrylamide or dimethylaminopropyl(meth)acrylamide;
ethyleneimine, vinylamine, 2-vinylpyridine or 4-vinylpyridine;
trimethylammonium ethyl (meth)acrylate chloride, trimethylammonium ethyl acrylate methyl sulfate, benzyldimethylammonium ethyl (meth)acrylate chloride, 4-benzoylbenzyldimethylammonium ethyl acrylate chloride, trimethylammonium ethyl(meth)acrylamide chloride or trimethylvinylbenzylammonium chloride;
diallyldimethylammonium chloride;
   alone or as mixtures, or their corresponding salts, and the macromonomers deriving from such monomers.

The polymer according to the invention can be either a random polymer or a block polymer or a polymer with a star structure.

The random or block polymers are more particularly linear polymers.

If the polymer is in the random form, it may or may not have a concentration gradient along the chain.

In the case where the polymer has a block structure, the number of blocks can be two or three. However, in the case of such a structure, each of the blocks of the polymer can be either a homopolymer or a random copolymer or a copolymer exhibiting a concentration gradient.

In addition, in the case of a diblock polymer, preferably only one of the blocks is obtained from at least one monomer comprising boron.

In the case of a triblock polymer, according to a first specific embodiment, one block is obtained from at least one monomer carrying boron; this block may or may not be situated at the end of said polymer. According to this embodiment, the two blocks not comprising boron may or may not have the same composition. According to another specific embodiment, two blocks of the polymer can be obtained from at least one monomer carrying boron; said blocks are preferably situated at the ends of the polymer. Furthermore, it is specified that the composition of the two blocks comprising boron may or may not be identical.

Finally, in the case where the polymer according to the invention has a star structure, each of the branches can be either a homopolymer or a random copolymer or a block copolymer within the above meaning or a copolymer exhibiting a concentration gradient.

It is specified that directly adjacent blocks, whether they constitute the various fragments of a block polymer or of a polymer with a star structure, are differentiated from one another in that their chemical composition is different. The term “different chemical composition” is understood to mean more particularly that the chemical nature of at least one of the monomers is different from one block to another and/or that the respective proportions of the monomers are different from one block to another.

It should be remembered that the copolymer employed in the present invention comprises more than five monomer repeat units.

The weight-average molar mass is more particularly between 1000 and 300 000 g/mol, preferably between 50 000 and 100 000 g/mol. It should be remembered that the weight-average molar mass is measured by steric exclusion chromatography coupled to the MALLS (Multi Angle Laser Light Scattering) method.

Still in the case of random or diblock polymers, the polydispersity index of the chains, corresponding to the weight-average molar mass/number-average molar mass ratio is advantageously less than or equal to 4, more particularly less than or equal to 2.5, preferably less than or equal to 2, more preferably still less than or equal to 1.5. It should be noted that, in the case of random polymers and for the evaluation of the polydispersity index, the polymer is considered to possess a single block.

It should be remembered that, in the case of uncontrolled polymerization, the index is always greater than that obtained by controlled polymerization.

In the case of polymers with a star structure, the weight-average molar mass is more particularly between 5000 and 5×10⁶ g/mol, preferably between 20 000 and 2×10⁶ g/mol.

With regard to the polydispersity index of the polymers with a star structure, it is advantageously less than or equal to 4, more particularly less than or equal to 2.5, preferably less than or equal to 2, more preferably still less than or equal to 1.5, for each arm of the star.

The polymers according to the invention are obtained by carrying out a controlled radical polymerization.

Reference may in particular be made, as examples of “living” or “controlled” polymerization processes, to:
the processes of applications WO 98/58974, WO 00/75207 and WO 01/42312, which employ a radical polymerization controlled by control agents of xanthate type,
the process for radical polymerization controlled by control agents of dithioester type of application WO 98/01478,
the process of application WO 99/03894, which employs a polymerization in the presence of nitroxide precursors,
the process for radical polymerization controlled by control agents of dithiocarbamate type of application WO 99/31144,
the process for radical polymerization controlled by control agents of dithiocarbazate type of application WO 02/26836,
the process for radical polymerization controlled by control agents of dithiophosphoro ester type of application WO 02/10223,
the process of application WO 96/30421, which uses atom transfer radical polymerization (ATRP),
the process for radical polymerization controlled by control agents of iniferter type according to the teaching of Otu et al., Makromol. Chem. Rapid. Commun., 3,127 (1982),
the process for radical polymerization controlled by degenerative transfer of iodine according to the teaching of Tatemoto et al., Jap. 50, 127, 991 (1975), Daikin Kogyo Co. Ltd, Japan, and Matyjaszewski et al., Macromolecules, 28, 2093 (1995),
the process for radical polymerization controlled by tetraphenylethane derivatives disclosed by D. Braun et al. in Macromol. Symp., 111, 63 (1996), or
the process for radical polymerization controlled by organocobalt complexes described by Wayland et al. in J. Am. Chem. Soc., 116, 7973 (1994).

The processes for the preparation of polymers in the star form can be essentially classified into two groups. The first corresponds to the formation of the arms of the polymers starting from a polyfunctional compound constituting the center (core-first technique) (Kennedy, J. P. et al., Macromolecules, 29, 8631 (1996), Deffieux, A. et al., ibid, 25, 6744, (1992), Gnanou, Y. et al., ibid, 31, 6748 (1998)) and the second corresponds to a method where the polymer molecules which will constitute the arms are first synthesized and subsequently together bonded to a core to form a polymer in the star form (arm-first technique).

As example of the synthesis of this type of polymer, reference may be made to patent WO 00/02939.

Generally, it is preferable for the block copolymers employed according to the invention to result from a controlled radical polymerization process employing, as control agent, one or more compounds chosen from dithioesters, thioethers-thiones, dithiocarbamates and xanthates.

In a particularly advantageous way, the block copolymers used according to the invention result from a controlled radical polymerization carried out in the presence of control agents of xanthate type.

According to a preferred embodiment, the block copolymer used can be obtained according to one of the processes of applications WO 98/58974, WO 00/75207 or WO 01/42312, which employ a radical polymerization controlled by control agents of xanthate type, it being possible for said polymerization to be carried out in particular under bulk conditions, in a solvent or in an aqueous emulsion.

Advantageously, the polymerization medium is chosen so that it corresponds to the medium for final application of the polymer. This facilitates the use of said polymer as it can be used without intermediate isolation or purification before application.

Thus, it is possible to employ a process comprising the following stages:
(a) the following are brought into contact:
   ethylenically unsaturated monomers,
   a source of free radicals, and
   at least one control agent of formula (I): 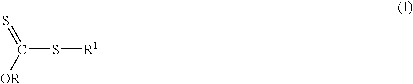
in which:
   R represents:
      H or Cl;
      an alkyl, aryl, alkenyl or alkynyl group;
      a saturated or unsaturated, optionally aromatic, carbonaceous ring;
      a saturated or unsaturated, optionally aromatic, heterocycle;
      an alkylthio group;
      an alkoxycarbonyl, aryloxycarbonyl, carboxyl, acyloxy or carbamoyl group;
         a cyano, dialkyl- or diarylphosphonato, or dialkyl- or diarylphosphinato group;
         a polymer chain;
      an (R²)O— or (R²)(R′²)N— group, in which the R² and R′² radicals, which are identical or different, each represent:
         an alkyl, acyl, aryl, alkenyl or alkynyl group;
      a saturated or unsaturated, optionally aromatic, carbonaceous ring; or
         a saturated or unsaturated, optionally aromatic, heterocycle; and
   R¹ represents:
      an alkyl, acyl, aryl, alkenyl or alkynyl group;
      a saturated or unsaturated, optionally aromatic, carbonaceous ring;
      a saturated or unsaturated, optionally aromatic, heterocycle; or
      a polymer chain;
(b) following stage (a), a controlled radical polymerization stage or several successive controlled radical polymerization stages is/are carried out, where, at each stage, the following are brought into contact:
   ethylenically unsaturated monomers other than those employed in the preceding stage,
      a source of free radicals, and
      the functionalized polymer resulting from the preceding stage.

It is understood that one of the polymerization stages (a) and (b) defined above results in the formation of the anchoring block and that another of the polymerization stages of stages (a) and (b) results in the formation of another block.

It should in particular be noted that the ethylenically unsaturated monomers employed in the stages (a) and (b) are chosen from the monomers as defined above.

The polymerization stages (a) and (b) are generally carried out in a solvent medium composed of water and/or of an organic solvent, such as tetrahydrofuran or a linear, cyclic or branched C₁-C₈ aliphatic alcohol, such as methanol, ethanol or cyclohexanol, or a diol, such as ethylene glycol.

Optionally, the polymers synthesized can be subjected to a reaction for the purification of their sulfur-comprising chain end, for example by processes of hydrolysis, oxidation, reduction, pyrolysis or substitution type.

Another subject-matter of the present invention is composed of a combination comprising the polymer which has just been described with at least one ligand compound having at least one group capable of complexing with a boronate or precursor functional group of the polymer according to the invention.

According to a preferred embodiment of the invention, the ligand compound exhibits at least two groups capable of reacting with a boronate or precursor functional group of the polymer according to the invention. Advantageously, the two reactive groups are carried by vicinal atoms (or adjacent atoms, 1,2 position) or by two atoms separated by an additional atom (1,3 position). Advantageously, the atoms are carbon atoms.

In accordance with a preferred embodiment of the invention, the two reactive groups are found in the cis position with respect to one another.

Preferably, the groups capable of reacting with a boronate functional group are hydroxyl groups, originating from alcohol and/or carboxylic acid functional groups, optionally in combination with amine groups, more particularly primary or secondary amine groups.

Thus, the ligand compound can comprise at least one or more groupings of at least two hydroxyl groups, originating from alcohol and/or carboxylic acid functional groups, one or more groupings of at least one hydroxyl group, originating from alcohol and/or carboxylic acid functional groups, in combination with at least one amine group, preferably a primary or secondary amine group, or alternatively the composite of these two possibilities.

According to a first embodiment, the ligand compound is a monomer, an oligomer or a polymer having the reactive group or groups which have just been described.

The ligand compound can likewise be a macroscopic surface, whether the latter is synthetic, of polymeric or nonpolymeric origin, or alternatively natural, provided that it has the appropriate group or groups which have just been described above. In this scenario, the ligand compound can be a particle (organic or inorganic) of nanometric or micronic size, provided that it also has the appropriate group or groups described above. Silica particles are an example thereof.

If the ligand compound is a monomer, the latter is preferably chosen from compounds comprising one or more groupings of at least two hydroxyl groups, originating from alcohol and/or carboxylic acid functional groups, one or more groupings of at least one hydroxyl group, originating from alcohol and/or carboxylic acid functional groups, in combination with at least one amine group, preferably a primary or secondary amine group, or alternatively the combination of these two possibilities.

If the ligand compound is an oligomer, the latter more especially has from 2 to 5 repeat units.

Furthermore, it is chosen from compounds, at least one of the repeat units of which has one or more groupings of at least two hydroxyl groups, originating from alcohol and/or carboxylic acid functional groups, one or more groupings of at least one hydroxyl group, originating from alcohol and/or carboxylic acid functional groups, in combination with at least one amine group, preferably a primary or secondary amine group, or alternatively the combination of these two possibilities. Furthermore, it can be chosen from compounds, at least two repeat units of which have at least one hydroxyl group each, or one has at least one hydroxyl group and the other has at least one hydroxyl group or at least one amine group, so that, once the two units are combined in the oligomer, the two reactive functional groups are carried either by two vicinal atoms or by two atoms separated by an additional atom.

Mention may be made, as monomers or oligomers which can be used, of compounds comprising a diol, triol, α-hydroxycarboxylic acid, hydroxyamine, amino acid or dicarboxylic acid functional group. Mention may be made, as examples of such compounds, and without intending to be limited thereto, of 1,2- or 1,3-pentanediol, benzenediol, 1,2,3-pentanetriol, mannitol, oxalic acid, succinic acid, glycolic acid or lactic acid.

Use may also be made of monomers or oligomers comprising at least one glycoside functional group.

Thus, mention may be made, as suitable compounds, without intending to be limited, of glucose, mannose, galactose, fructose, xylose, and the monomers and oligomers described in the paper by R. J. Ferrier, Advances in Carbohydrate Chemistry, 1978, vol. 35, pp. 31-81, 1978.

The ligand compound can also be chosen from surfactants comprising sugar heads, such as, for example, alkylpolyglucosides.

If the ligand compound is a polymer, the latter comprises more than 5 repeat units.

In addition, it is preferably chosen from compounds, of which at least one of the monomers from which it is obtained has one or more groupings of at least two hydroxyl groups, originating from alcohol and/or carboxylic acid functional groups, one or more groupings of at least one hydroxyl group, originating from alcohol and/or carboxylic acid functional groups, in combination with at least one amine group, preferably a primary or secondary amine group, or alternatively the combination of these two possibilities. Furthermore, it can be chosen from compounds, at least two monomers of which have at least one hydroxyl group each, or one has at least one hydroxyl group and the other has at least one hydroxyl group or at least one amine group, so that, once the two monomers are combined in the polymer, the two reactive functional groups are carried either by two vicinal atoms or by two atoms separated by an additional atom.

It is preferable to use polymers exhibiting a weight-average molar mass of greater than or equal to 2000 g/mol, preferably of greater than or equal to 10⁵ g/mol (absolute masses, measured by steric exclusion chromatography coupled to the MALLS method).

Mention may be made, among suitable polymers, of synthetic polymers, such as poly(vinyl alcohol), partially hydrolyzed poly(vinyl acetate), copolymers comprising dihydroxyethyl (meth)acrylate or glyceryl (meth)acrylate, for example.

Mention may likewise be made of polymers comprising at least one glycoside unit. The monomers and oligomers listed above are suitable for this embodiment and reference may be made thereto.

As regards the polymers having at least one glycoside unit, some natural or modified polysaccharides of animal or plant origin, and biogums, exhibiting the reactive groups described above, are also suitable.

Mention may be made, as natural polysaccharides, without being limited, of alginates, galactomannans, such as guar gum, locust bean gum, tara gum or cassia gum; karaya gum; carrageenans, in particular A-carrageenan; chitin derivatives, such as chitosan; starches; glucomannans; dextran; or pullulan.

Use may likewise be made of the derivatives of these polymers modified so as to exhibit a cationic nature, such as cationic derivatives of guar or of locust bean (Jaguar® C13S and Jaguar® C162, sold by Rhodia Chimie). Use may also be made of nonionic derivatives of these polymers, such as hydroxypropyl guars, anionic derivatives, such as carboxymethyl guars, or nonionic/anionic mixed derivatives, such as carboxyhydroxypropyl guars, or nonionic/cationic mixed derivatives, such as ammonium hydroxypropyl guars.

Mention may also be made, as modified polysaccharides which can come within the scope of the present invention, of cellulose derivatives, such as dihydroxypropyl cellulose or other hydroxyalkylated cellulose derivatives.

Mention may in particular be made, as biogums which can be used in the context of the combination according to the invention, of the polysaccharides obtained by fermentation under the action of bacteria or fungi belonging, for example, to the genus Xanthomonas, to the genus Arthrobacter, to the genus Azobacter, to the genus Agrobacter, to the genus Alcaligenes, to the genus Rhizobium, to the genus Sclerotium, to the genus Corticium or to the genus Sclerotinia.

Mention may more particularly be made, as examples of biogums, of xanthan gum, scleroglucans or succinoglycans.

It should be noted that the abovementioned polysaccharides can be employed in the native form or in a form chemically modified so as to confer on them an ionic or nonionic nature different from that of the native form.

Mention may be made among polymers, of which at least one of the monomer units comprises at least one hydroxyl group and one amine group, by way of examples, of some proteins, or polymers obtained in particular from amino acids.

Use may also be made of the same compounds, generally in the form of water-soluble polymers modified by hydrophobic groups covalently bonded to the polymer backbone, as disclosed in patent EP 281 360.

Of course, it would not be parting from the scope of the present invention to use, as ligand compound, a mixture of one or more of the entities described above.

Preferably, use will be made, as ligand compound, of at least one polymer chosen from polysaccharides, such as galactomannans (guar or locust bean, preferably) or glucomannans and their derivatives, poly(vinyl alcohol), partially hydrolyzed poly(vinyl acetate), or copolymers comprising glyceryl (meth)acrylate.

The content of ligand compound in the final application, whether in the monomer, oligomer or polymer form, is between 0.01% and 50% by weight of the formulation used, preferably between 0.05 and 10%.

In this same formulation, the ratio of the content by weight of polymer comprising boronate functional group to the content by weight of ligand compound (monomer, oligomer or polymer) is between 0.001 and 1000, preferably between 0.01 and 100, preferably between 0.1 and 10.

In the case where the ligand compound is a surface, the content of polymer comprising boronate functional group is such that it makes it possible to deposit on the surface of greater than or equal to 0.05 mg/m², advantageously of greater than or equal to 0.1 mg/m², preferably of greater than or equal to 0.5 mg/m².

It is specified that the maximum amount of polymer comprising boronate functional group deposited is determined according to the applications and the cost. It is usually less than or equal to 1 g/m², more generally less than or equal to 10 mg/m² and more particularly less than or equal to 2 mg/m². The amount of polymer deposited is measured by conventional surface analysis techniques, such as ellipsometry or titration by depletion of the unadsorbed polymer.

One of the methods for the preparation of the combination according to the invention consists in bringing the polymer comprising boronate or precursor functional group into contact with at least one ligand compound.

The stage of bringing into contact is advantageously carried out in solution, preferably aqueous solution. It should be noted that this solution may or may not comprise specific ingredients of complete formulations.

If the ligand compound is a surface, the polymer comprising boronate functional group or a solution of the latter is generally applied to said surface by spraying, immersion, and the like.

The temperature at which the polymer comprising boronate functional group and the ligand compound are brought into contact can vary within a wide range.

Usually, the temperature is between 15 and 40° C.

Depending on the nature of the groups present, the boronate functional groups of the polymer according to the invention and those of the ligand may react as soon as they come into contact or else may require the use of specific stages in order for the reaction to be possible.

In the case where the polymer according to the invention exhibits boronate functional groups, preferably in the salt form, the reaction of the functional groups with those of the ligand compound does not require an additional stage.

In the case where the polymer according to the invention exhibits boronic acid functional groups or precursor functional groups within the meaning mentioned above, it may be advantageous to carry out a hydrolysis or neutralization stage, in particular by modifying the pH of the solution. The object of this operation is in particular to bring about the appearance of boronate functional groups in the salt form.

For example, in the case where the functional groups of the ligand compound are hydroxyl groups originating from alcohol functional groups, it is sufficient to bring the pH close to or above the pK value of the boronic functional group.

Conventionally, the pH range is between 8 and 14. However, it should be specified that this value is given only by way of indication. This is because, depending on the structure of a polymer comprising boronate functional group and on the addition of ionic monomers, more particularly cationic amino monomers or amino monomers which can be converted to a cation, on the nature of the ligand, it is possible to modify the stability range as a function of the pH of the polymer comprising boronate functional group/ligand compound complexes.

It is also possible to lower the stability range as a function of the pH of the said complex to values of 6-7 by preparing a polymer according to the invention starting from monomers carrying boron atoms and exhibiting a lower pK. Such monomers in particular carry substituent groups on the aromatic nucleus.

It is indicated that this hydrolysis or neutralization stage, in particular the pH variation, can only be carried out once the polymer comprising boronate functional group has been brought into contact with the ligand compound. In such a scenario (optionally during the application of a formulation), the complexing of the polymer comprising boronate functional group and the ligand compound is triggered by the addition of a substance which modifies the pH of the formulation in which the two compounds are found. The reverse is entirely possible, namely to modify the pH by addition of the appropriate substance so as to render the pH incompatible with complexing.

In the case where the polymer according to the invention comprises boronic acid functional groups or precursor functional groups, another possibility consists in carrying out a heat treatment of the polymer comprising boronate functional group/ligand compound grouping. This heat treatment will have the effect of activating the reaction of the functional groups with one another.

The temperature at which this stage is carried out can be easily determined by a person skilled in the art and very obviously remains below the decomposition temperature of the opposing entities.

By way of indication, the temperature is greater than or equal to 100° C., indeed even greater than or equal to 150° C.

This possibility of activation by heat treatment can, for example, be employed in the case where the ligand compound is cellulose or a derivative.

Finally, a last subject matter of the invention is composed of the use of this combination under conditions such that the concentration of polymer comprising boronate functional group during use is between 0.001 and 50% by weight in the aqueous medium, preferably between 0.01 and 10% by weight, more preferably still between 0.05 and 2% by weight.

This combination, in liquid medium and particularly in aqueous medium, gives access to “hybrid” polymers composed of the polymer comprising boronate functional group/ligand compound entity. These “hybrid” polymers, depending on the nature of the chain of the boronate-comprising polymer, can modify the properties of hydrophilicity or of hydrophobicity and the ionic nature of the ligand compound with which the polymer comprising boronate functional group is combined.

These modifications in structure can likewise condition a specific rheological behavior.

They can also make it possible to vectorize the combination of one of the two components of this combination onto a surface, for example by introducing into the polymer in combination an affinity with the surface which it did not have previously.

It should be noted, and this also represents certain advantages, that, depending on the conditions of use (in particular pH, the presence of a competitive compound, the role of which is to destabilize the boronate-comprising polymer and ligand compound complex), these properties can be triggered or withdrawn, according to whether these conditions are favorable or not to the formation of the bonds between the boronate functional groups and the reactive functional groups of the ligand compound.

The combination according to the invention may find applications in various fields, such as cosmetics, detergency, industrial cleaning, in particular with the treatment of metals, agrochemistry, health, the preparation of paints and paper, oil drilling, construction, and the like.

Concrete but nonlimiting examples of the invention will now be presented.

### EXAMPLES

### Example 1

### p(St)-r-P(AA) with boronate (polymer A)

First Stage:

380 g of water, 2.92 g of sodium dodecyl sulfate and 0.15 g of sodium carbonate are introduced, at ambient temperature with stirring, into a two liter jacket glass reactor equipped with a mechanical stirrer and maintained under an inert atmosphere.

The medium is subsequently placed at 85° C. 4.23 g of O-ethyl S-(1-methoxycarbonyl)ethyl xanthate [(CH₃CHCO₂CH₃)S(C═S)OEt], 6 g of styrene and 0.1 g of methacrylic acid are added to the medium at this temperature. After homogenizing for 5 minutes, a solution of 0.93 g of ammonium persulfate in 12.35 g of water is added. A mixture of 54 g of styrene, 383 g of ethyl acrylate, 7.8 g of methacrylic acid and 3 g of 4-vinylphenylboronic acid is then introduced over three hours.

At the same time as the introduction of the monomers, a solution of 0.46 g of sodium carbonate in 125 g of water is introduced over 3 hours. After introducing the reactants for two hours, a solution of 0.60 g of ammonium persulfate in 10 g of water is introduced. The reaction is maintained for three hours after the end of the introduction of the reactants.

A sample is then withdrawn and analyzed by steric exclusion chromatography (SEC).

Its number-average molar mass Mn is equal to 27 000 g/mol (calibration by linear polystyrene standards).

Its polydispersity index Mw/Mn is 2.71.

Analysis of the sample by gas chromatography reveals that the conversion of the monomers is greater than 98%. In particular, the concentration of residual 4-vinylphenylboronic acid is less than 5 ppm (measured by HPLC (high performance liquid chromatography)).

Second Stage:

At the end of the synthesis described in the first stage, 426 g of the copolymer emulsion are maintained at 85° C. and 335 g of water are then added. The temperature is subsequently reduced to 75° C. and a mixture of 498 g of water and 109 g of isopropanol is added to the latex. 211 g of sodium hydroxide solution with a concentration of 7.25N are then introduced over a period of two hours. Hydrolysis is maintained for two hours after the end of the introduction of the sodium hydroxide.

At the end of the hydrolysis, an aqueous polymer is obtained. ¹H NMR analysis of the copolymer resulting from the hydrolysis reveals that the sodium hydroxide has been completely consumed, creating sodium acrylate sites on the polymer chain.

### Example 2

### p(St)-b-P(AA) with boronate (polymer B)

First Stage:

380 g of water, 2.92 g of sodium dodecyl sulfate and 0.15 g of sodium carbonate are introduced, at ambient temperature with stirring, into a two liter jacket glass reactor equipped with a mechanical stirrer and maintained under an inert atmosphere.

The medium is subsequently placed at 85° C. 4.23 g of O-ethyl S-(1-methoxycarbonyl)ethyl xanthate [(CH₃CHCO₂CH₃)S(C═S)OEt], 6 g of styrene and 0.1 g of methacrylic acid are added to the medium at this temperature. After homogenizing for 5 minutes, a solution of 0.93 g of ammonium persulfate in 12.35 g of water is added. A mixture of 54 g of styrene and 0.89 g of methacrylic acid is then introduced over one hour. The reaction medium is maintained at this temperature for one hour after the end of the introduction.

A sample is then withdrawn and analyzed by steric exclusion chromatography (SEC). Its number-average molar mass Mn is equal to 3300 g/mol (calibration by linear polystyrene standards).

Its polydispersity index Mw/Mn is 2.39.

Mw represents the weight-average molar mass of the polymer.

The reaction is continued by introducing a solution of 0.46 9 of ammonium persulfate in 10 g of water and then by adding a mixture of 345 9 of ethyl acrylate and 6.91 9 of methacrylic acid over 2h 45.

At this point, a solution of 37.6 g of ethyl acrylate and 3 g of 4-vinylphenylboronic acid is introduced over 15 minutes. At the same time as the introduction of the monomers, a solution of 0.46 g of sodium carbonate in 125 g of water is introduced over 3 hours. After introducing the reactants for two hours, a solution of 0.46 g of ammonium persulfate in 10 g of water is introduced.

The reaction is maintained for three hours after the end of the introduction of the reactants.

A sample is then withdrawn and analyzed by steric exclusion chromatography (SEC). Its number-average molar mass Mn is equal to 23 900 g/mol (calibration by linear polystyrene standards).

Its polydispersity index Mw/Mn is 3.55.

Analysis of a sample by gas chromatography reveals that the conversion of the monomers is greater than 99%. In particular, the concentration of residual 4-vinylphenylboronic acid is less than 5 ppm (measured by HPLC (high performance liquid chromatography)).

Second Stage:

At the end of the synthesis described in the first stage, 426 g of the copolymer emulsion are maintained at 85° C. and 335 g of water are then added.

The temperature is subsequently reduced to 75° C. and a mixture of 498 g of water and 109 g of isopropanol is added to the latex. 211 g of sodium hydroxide solution with a concentration of 7.25N are then introduced over a period of two hours. Hydrolysis is maintained for two hours after the end of the introduction of the sodium hydroxide.

At the end of the hydrolysis, a highly viscous aqueous gel is obtained.

¹H NMR analysis of the copolymer resulting from the hydrolysis reveals that the sodium hydroxide has been completely consumed, creating sodium acrylate sites on the polymer chain.

It should be noted that the uncontrolled radical polymerization does not make it possible to obtain the block structures desired.

### Example 3, Comparative

### p(St)-b-p(AA) without boronate (polymer C)

First Stage:

380 9 of water, 2.92 g of sodium dodecyl sulfate and 0.15 g of sodium carbonate are introduced, at ambient temperature with stirring, into a two liter jacket glass reactor equipped with a mechanical stirrer and maintained under an inert atmosphere.

The medium is subsequently placed at 85° C. 4.23 g of O-ethyl S-(1-methoxycarbonyl)ethyl xanthate [(CH₃CHCO₂CH₃)S(C═S)OEt], 6 g of styrene and 0.1 g of methacrylic acid are added to the medium at this temperature. After homogenizing for 5 minutes, a solution of 0.93 g of ammonium persulfate in 12.35 g of water is added. A mixture of 54 g of styrene and 0.89 g of methacrylic acid is then introduced over one hour. The reaction medium is maintained at this temperature for one hour after the end of the introduction.

A sample is then withdrawn and analyzed by steric exclusion chromatography (SEC). Its number-average molar mass Mn is equal to 3400 g/mol (calibration by linear polystyrene standards).

Its polydispersity index Mw/Mn is 2.31. Mw represents the weight-average molar mass of the polymer.

The reaction is continued by introducing a solution of 0.46 g of ammonium persulfate in 10 g of water and then by adding a mixture of 386.2 g of ethyl acrylate and 6.91 g of methacrylic acid over 3 hours.

At the same time as this introduction, a solution of 0.46 g of sodium carbonate in 125 g of water is introduced.

After introducing the reactants for two hours, a solution of 0.46 g of ammonium persulfate in 10 g of water is introduced.

The reaction is maintained for three hours after the end of the introduction of the reactants.

A sample is then withdrawn and analyzed by steric exclusion chromatography (SEC). Its number-average molar mass Mn is equal to 22 400 g/mol (calibration by linear polystyrene standards). Its polydispersity index Mw/Mn is 2.62.

Analysis of the sample by gas chromatography reveals that the conversion of the monomers is greater than 99%.

Second Stage:

At the end of the synthesis described in the first stage, 426 g of the copolymer emulsion are maintained at 85° C. and 335 g of water are then added.

The temperature is subsequently reduced to 75° C. and a mixture of 498 g of water and 109 g of isopropanol is added to the latex. 211 g of sodium hydroxide solution with a concentration of 7.25N are then introduced over a period of two hours. Hydrolysis is maintained for two hours after the end of the introduction of the sodium hydroxide.

At the end of the hydrolysis, a highly viscous aqueous gel is obtained. ¹H NMR analysis of the copolymer resulting from the hydrolysis reveals that the sodium hydroxide has been completely consumed, creating sodium acrylate sites on the polymer chain.

### Example 4

### Use of the B and C polymers

Two aqueous formulations B1 and C1 at a concentration of 2% in water of the preceding respective polymers B and C, at a pH of 10 (adjustment by addition of sodium hydroxide) are prepared.

An aqueous solution G comprising 0.74% by weight of native guar (ref. Rhodia CSA200/50; weight-average molar mass of 2×10⁶ g/mol) at a pH of 10, is prepared.

An equal weight of G and of the formulations B1 and C1 are mixed at 25° C. by simple mechanical stirring to produce the formulations B2 and C2 comprising, in the end: for B2: 0.37% of guar and 1% of polymer B for C2: 0.37% of guar and 1% of polymer C

The viscosities of the two preceding formulations are measured at 25° C. for a shear gradient of 1 s⁻1 using a Carrimed CSL100 rheometer (cone/plate geometry):

Viscosity (B2)=100 Pa·s

Viscosity (C2)=10 Pa·s

The desired advantage in the example is the maximum viscosity at low shear (1 s⁻¹).

The example clearly shows that, at an equal concentration of active principle, the use of the polymer comprising boronate functional group makes it possible to introduce an advantage with respect the polymer not comprising a boronate functional group; specifically, the viscosity of the B2 system is much greater than the viscosity of the C2 system.

Furthermore, it is noted that, when the B2 system is brought to a pH of 7 by addition of hydrochloric acid, the viscosity of the formulation changes from 100 to 10 Pa·s. The systems obtained offer the possibility of being “activated” or “deactivated” according to an external criterion, such as the pH.

It should be noted that, if the polymerization to produce a polymer of B type is not controlled, the polymer comprising boronate functional group obtained does not have the desired block structure and does not make it possible to obtain the desired viscosity advantages.

1-29. (canceled)

30. A polymer being obtained by controlled radical polymerization of at least one monomer comprising a boronate or precursor functional group and of at least one monomer which is devoid thereof.

31. The polymer as claimed in claim 30, wherein the monomer comprising the boronate or precursor functional group is acryloylbenzeneboronic acid, methacryloylbenzeneboronic acid, 4-vinylbenzeneboronic acid, 3-acrylamidophenylboronic acid or 3-methacrylamidophenylboronic acid, or the salts thereof.

32. The polymer as claimed in claim 31, having a molar proportion of monomer comprising the boronate or precursor functional group with respect to the total number of moles of monomers present in the polymer of between 0.01 and 50%.

33. The polymer as claimed in claim 30, wherein the monomer devoid of boronate or precursor functional group is:
esters of linear, branched, cyclic or aromatic mono- or polycarboxylic acids comprising at least one ethylenic unsaturation,
esters of saturated carboxylic acids comprising 8 to 30 carbon atoms, optionally carrying a hydroxyl group;
α,β-ethylenically unsaturated nitriles, vinyl ethers, vinyl esters, vinylaromatic monomers, vinyl halides or vinylidene halides,
linear or branched and aromatic or nonaromatic hydrocarbonaceous monomers comprising at least one ethylenic unsaturation,
or the macromonomers deriving from such monomers.

34. The polymer as claimed in claim 30, wherein the monomer devoid of boronate or precursor functional group is amides of linear, branched, cyclic or aromatic mono- or polycarboxylic acids comprising at least one ethylenic unsaturation, or derivatives; hydrophilic esters deriving from (meth)acrylic acid; or vinyl esters which make it possible to obtain poly(vinyl alcohol) blocks after hydrolysis; or the macromonomers deriving from such monomers.

35. The polymer as claimed in claim 30, wherein the monomer devoid of boronate or precursor functional group is monomers comprising at least one carboxylic, sulfonic, sulfuric, phosphonic, phosphoric or sulfosuccinic functional group, or the corresponding salts.

36. The polymer as claimed in claim 35, wherein the monomer devoid of boronate or precursor functional group is:
linear, branched, cyclic or aromatic mono- or polycarboxylic acids, the N-substituted derivatives of such acids, or the monoesters of polycarboxylic acids, comprising at least one ethylenic unsaturation;
linear, branched, cyclic or aromatic vinylcarboxylic acids;
amino acids comprising one or more ethylenic unsaturations;
or their precursors, their sulfonic or phosphonic derivatives, and the macromonomers deriving from such monomers; it being possible for the monomers or macromonomers to be in the form of salts.

37. The polymer as claimed in claim 30, wherein the monomer devoid of boronate or precursor functional group is:
aminoalkyl (meth)acrylates or aminoalkyl(meth)acrylamides;
monomers comprising at least one secondary, tertiary or quaternary amine functional group or one heterocyclic group comprising a nitrogen atom, vinylamine or ethyleneimine;
diallyldialkylammonium salts;
or the corresponding salts, and the macromonomers deriving from such monomers.

38. The polymer as claimed in claim 30, wherein the polymer is a random polymer or a polymer exhibiting a concentration gradient.

39. The polymer as claimed in claim 30, wherein the polymer is a block polymer, each of the blocks of which being a homopolymer or a random copolymer or a copolymer exhibiting a concentration gradient.

40. The polymer as claimed in claim 30, wherein the polymer is linear.

41. The polymer as claimed in claim 30, having a weight-average molar mass of between 1000 and 300 000 g/mol.

42. The polymer as claimed in claim 30, wherein the polymer is a polymer with a star structure, each of the branches of which being a homopolymer or a random copolymer or a block copolymer or a copolymer exhibiting a concentration gradient.

43. The polymer as claimed in claim 42, wherein the weight-average molar mass is between 5000 and 5×10⁶ g/mol.

44. A combination comprising the polymer as defined in claim 30 with at least one ligand compound having at least one group, optionally at least two groups, capable of complexing with a boronate or precursor functional group of said polymer.

45. The combination as claimed in claim 44, wherein the ligand compound exhibits at least two groups capable of reacting with a boronate or precursor functional group of the polymer as claimed in the invention, said groups being carried by vicinal atoms or by two atoms separated by an additional atom.

46. The combination as claimed in claim 44, wherein the ligand compound exhibits at least two groups capable of reacting with a boronate or precursor functional group of the polymer as claimed in the invention, said groups being in the cis position with respect to one another.

47. The combination as claimed in claim 44, wherein the ligand compound comprises at least one or more groupings of at least two hydroxyl groups, originating from alcohol and/or carboxylic acid functional groups, one or more groupings of at least one hydroxyl group, originating from alcohol and/or carboxylic acid functional groups, in combination with at least one amine group, optionally a primary or secondary amine group, or alternatively the composite of these two possibilities.

48. The combination as claimed in claim 47, wherein the ligand compound is a monomer, an oligomer, a polymer or a synthetic macroscopic surface of polymeric or nonpolymeric origin or alternatively a natural macroscopic surface.

49. The combination as claimed in claim 44, wherein the ligand compound is a monomer or oligomer being 1,2- or 1,3-pentanediol, benzenediol, 1,2,3-pentanetriol, mannitol, oxalic acid, succinic acid, glycolic acid, lactic acid, glucose, mannose, galactose, fructose, xylose or a surfactant comprising alkylpolyglucosides.

50. The combination as claimed in claim 44, wherein the ligand compound is a polymer being a galactomannan, a glucomannan, poly(vinyl alcohol), partially hydrolyzed poly(vinyl acetate), or a copolymer comprising glyceryl (meth)acrylate.

51. The combination as claimed in claim 44, wherein the content of ligand compound in the final application, whether in the monomer, oligomer or polymer form, is between 0.01% and 50% by weight of the formulation used.

52. The combination as claimed in claim 51, having a ratio of the content by weight of polymer comprising boronate functional group to the content by weight of ligand compound of between 0.001 and 1000.

53. The combination as claimed in claim 44, wherein the ligand compound is a surface and the content of polymer comprising boronate functional group is such that it makes it possible to deposit on the surface an amount of polymer comprising boronate functional group of greater than or equal to 0.05 mg/m².

54. A process for the preparation of the combination as defined in claim 44, wherein the polymer comprising boronate or precursor functional group is brought into contact with at least one ligand compound.

55. The process as claimed in claim 54, wherein the operation of bringing into contact is carried out in solution, optionally aqueous solution.

56. The process as claimed in claim 54, wherein, in the case where the polymer exhibits boronic acid functional groups or precursor functional groups, a hydrolysis or neutralization stage is carried out on said functional groups.

57. The process as claimed in claim 54, wherein, in the case where the polymer exhibits boronic acid functional groups or precursor functional groups, a heat treatment is carried out on the polymer comprising boronate functional group/ligand compound grouping.

58. An aqueous medium comprising a combination as defined in claim 44, with a concentration such that the content by weight of polymer comprising boronate functional group is between 0.001 and 50% by weight in the aqueous medium.
